(19) United States
(12) Patent Application Publication
(10) Pub. No.: US 2024/0153727 A1
(43) Pub. Date: May 9, 2024

(54) PLUG-IN CIRCUIT BREAKER FOR SERIES MOUNTING, HAVING A BASE ELEMENT AND A PLUG, AND ENSEMBLE HAVING THE SAME

(71) Applicant: PHOENIX CONTACT GMBH & CO. KG, Blomberg (DE)

(72) Inventors: Beate RHEKER-SAGEBIEL, Marienmünster (DE); Andre HOLTKÄMPER, Berlin (DE)

(21) Appl. No.: 18/492,898

(22) Filed: Oct. 24, 2023

(30) Foreign Application Priority Data
Nov. 3, 2022 (DE) 10 2022 129 050.6

(51) Int. Cl. H01H 71/08

(52) U.S. Cl. CPC H01H 71/08

(57) ABSTRACT

The disclosure relates to a plug-in circuit breaker for series mounting, having a base element and a plug. The plug may include a circuit breaker, where it is possible to plug the plug into the base element in a detachable manner. The base element may include mounting elements for mounting on a mounting rail. The base element may also include at least one first electrical connector and at least one second electrical connector. The plug-in circuit breaker may also include at least one first bridging slot for a bridging plug being arranged in a plug-in region.

### CROSS-REFERENCE TO RELATED APPLICATION

This application claims the benefit of German Patent Application No. 10 2022 129 050.6 filed Nov. 3, 2022, the entire contents of which are incorporated by reference in its entirety.

### BACKGROUND

Thermomagnetic circuit breakers for equipment protect electrical equipment from overload and short-circuit currents. If these circuit breakers for equipment fail, then they must be replaced. To facilitate the replacement, solutions using a plug-in circuit breaker have already been proposed in the past.

Plug-in circuit breakers offer the further advantage that circuit breakers for equipment in different current classes can be provided and it is possible to react in a flexible manner to a required current class by using a suitable circuit breaker as a plug.

For example, a plug-in circuit breaker is known from the European patent EP 2 780 984 B1.

Using previous thermomagnetic solutions, it is only possible to a limited extent however to forward a potential protected by the circuit breaker to an adjacent terminal by means of standard material, to reproduce the potential and thus to expand the protection to a plurality of consumers. Furthermore, these solutions are disadvantageous, as when working on the connection to these terminals, it must be ensured that these terminals are de-energized. However, this step is often forgotten.

This necessitates special and therefore costly solutions or else an individual and therefore time-intensive wiring.

Although it is possible in the case of the plug-in solution known from the European patent EP 2 780 984 B1 to supply an adjacent terminal by means of a bridge, this only relates to the input potential. The protected output potential cannot be reproduced using a jumper.

### SUMMARY

The object of the invention is to provide a solution which makes it possible to provide a distribution of protected potentials in a cost-effective manner. Furthermore, it is an object of the invention to increase safety during mounting and maintenance.

The object is achieved by a plug-in circuit breaker for series mounting having a base element and a plug according to claim 1 and by an ensemble having a plug-in circuit breaker of this type and also a series terminal, which is arranged adjacent to the circuit breaker. Advantageous embodiments are the subject matter of the dependent claims, figures and description.

### BRIEF DESCRIPTION OF THE DRAWINGS

The invention is explained in more detail in the following, with reference to the attached drawings on the basis of preferred embodiments.

In the figures

FIG. 1 shows a schematic perspective illustration of embodiments of the invention in a mounted state,

FIG. 2 shows a schematic side illustration of an embodiment of the invention in a mounted state,

FIG. 3 shows a schematic side illustration of an embodiment of the invention in a demounted state, and

FIG. 4 shows a schematic side illustration of a part of an embodiment of the invention in a partially mounted state.

### DETAILED DESCRIPTION

The invention is described in more detail in the following with reference to the figure. In this case, it is to be noted that different aspects are described, which can respectively be used individually or in combination. That is to say, any aspect can be used with different embodiments of the invention, insofar as it is not explicitly presented as a pure alternative.

Furthermore, in the following, for the sake of simplicity, reference is generally always only made to one entity. Insofar as not explicitly noted, the invention can however also have a plurality of the relevant entities in each case. In this respect, the use of the words “a”, “an” and “one” is only to be understood as an indication that at least one entity is used in a single embodiment.

Reference is made to the images in the following description. In this case, identical or similar elements are generally labelled with the same or similar reference symbols.

The figures show a plug-in circuit breaker for series mounting, having a base element 2 and a plug 1.

In this case, the plug 1 has a circuit breaker. The circuit breaker can be of any desired type, but particularly a mechanical circuit breaker or else an electronic circuit breaker.

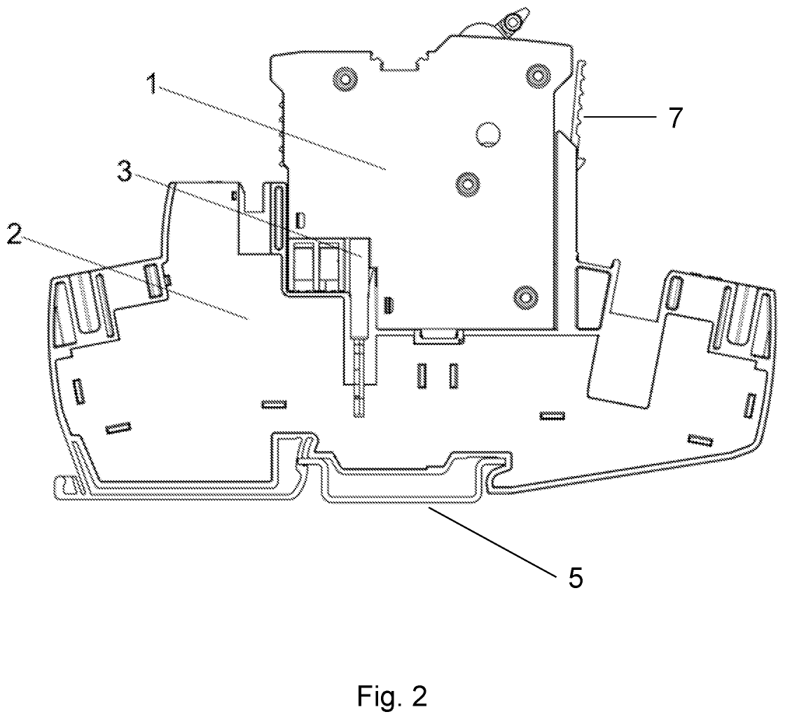

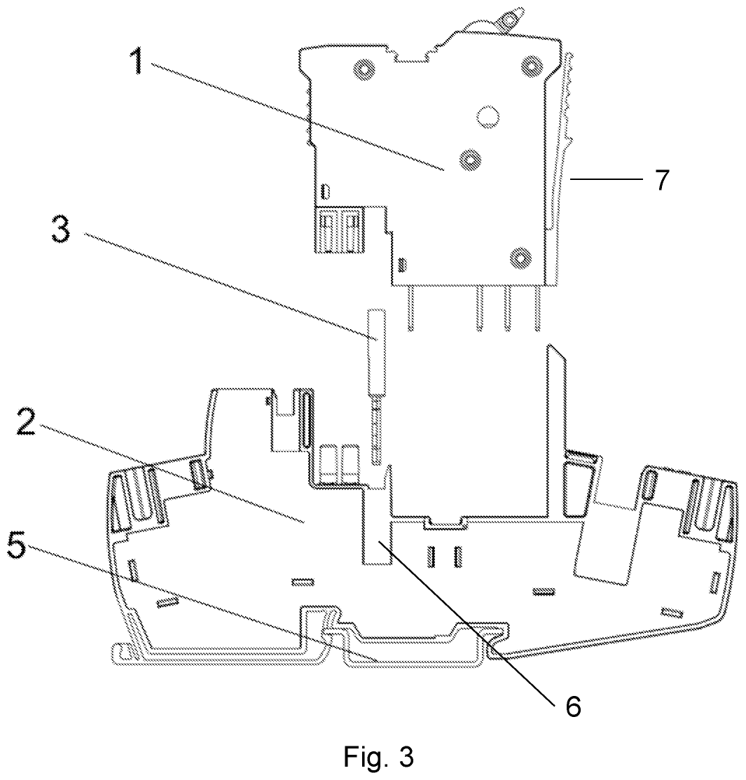

As is seen from the comparison of FIGS. 2 and 3, the plug 1 can be plugged into the base element 2 in a detachable manner. It may optionally be provided that the removal of the plug 2 from the base element requires the actuation of a (self-locking) release 7 or else the actuation of an eject mechanism. This may be provided on the plug and/or on the base element. The actuation of a release or the actuation of an eject mechanism may be tool-less or else require the use of a tool, such as e.g. a screwdriver.

Furthermore, the base element 2 has mounting elements for mounting on a mounting rail 5. These mounting elements may be configured in a tool-less manner, so that the base element can easily be disengaged on a mounting rail 5, for example a top-hat rail. To this end, spring-loaded elements can for example be formed on the base element 2—as shown in FIGS. 2-4.

The base element 2 has at least one first electrical connector 21 and one second electrical connector 22, wherein a first electrical connection (not illustrated) is led in the base element 2 from the first electrical connector 21 into the plug-in region, so that a plug 1 which is plugged-in and thus the circuit breaker is contacted, wherein a second electrical connection (not illustrated) is furthermore led in the base element 2 from the second electrical connector 22 into the plug-in region, so that a plug 1 which is plugged-in and thus the circuit breaker is contacted. That is to say, without a plug 1 which is plugged-in (and a functioning circuit breaker in the closed state), there is no electrical connection between the first electrical connector 21 and the second electrical connector 22.

At least one first bridging slot 6 for a bridging plug 3 is arranged in the plug-in region, which provides an electrical connection to the first electrical connector 21 or to the second electrical connector 22, wherein the plug 1 in the plugged-in state also covers a bridging plug 3, so that this bridging plug cannot be removed.

That is to say, during operation of the mounted plug-in circuit breaker, the circuit breaker has a supply via the first electrical connector 21 (input side) and provides a protected potential for energy distribution of the second electrical connector 22 (protected output side). The output side can in this case be electrically connected to the jumper 3. In the event of a fault, contacts open in the circuit breaker and the circuit breaker creates a (galvanic) isolation between input and output side and interrupts the flow of electricity. The circuit breaker typically protects AC voltages (typically up to 277 V) and DC voltages (typically up to 50 V).

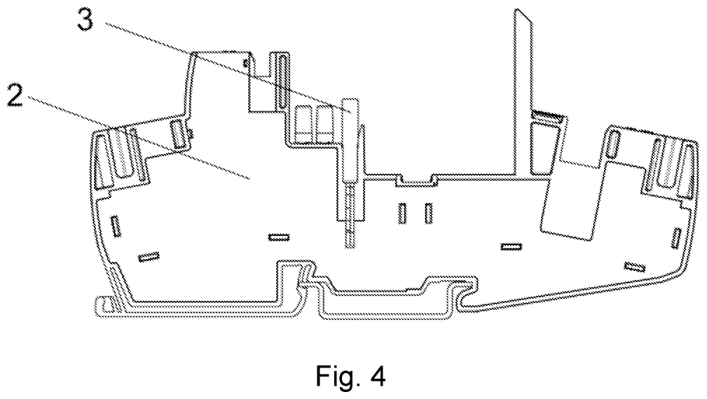

Unlike in the prior art, however, it is no longer possible for work to take place at the jumper 3 under voltage, as in order to reach the jumper 3 to be able to remove it or plug it in, it is necessary to remove the plug with the circuit breaker—see FIG. 4. In association with this however, the electrical connection from the supply side, i.e. the first electrical connector 21 to the second electrical connector 22 (downstream of the circuit breaker) and therefore also to the bridging slot 6 is interrupted, so that the jumper 3 can henceforth be plugged-in or unplugged safely. Therefore, there is however also protection for downstream parts of an electrical installation, which can be electrically connected by means of the plugged-in jumper 3.

According to an embodiment of the invention, at least one second bridging slot for a second bridging plug 3 can be arranged in the plug-in region, wherein the first bridging slot provides an electrical connection to the first electrical connector 21 and the second bridging slot provides an electrical connection to the second electrical connector 22.

That is to say that it may additionally be provided that an unprotected potential may be passed on. Thus, e.g. a plurality of plug-in circuit breakers for different electrical subsystems can be arranged next to one another on a mounting rail 5. The unprotected potential can be passed on by means of a jumper from a first base element 2 of a first plug-in circuit breaker to a second base element 3 of a second plug-in circuit breaker.

In a further embodiment, taps for sensor tips are provided on the base element 2.

Thus, it is possible to make measurements at the circuit breaker without further measures.

According to a further embodiment of the invention, the circuit breaker in the plug is a mechanical circuit breaker, particularly a thermomagnetic circuit breaker, or an electronic circuit breaker or a thermal circuit breaker.

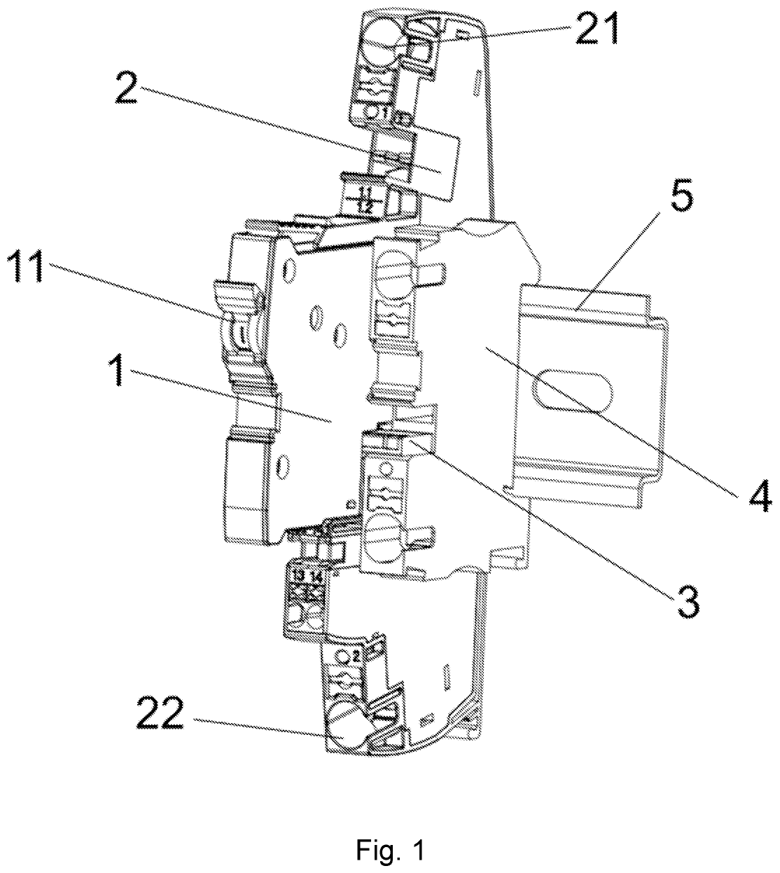

As already indicated previously and illustrated in FIG. 1, the invention also relates to an ensemble having a plug-in circuit breaker according to the invention and a series terminal 4, which is arranged adjacent to the circuit breaker, wherein, by means of a bridging plug 3, the series terminal 4 electrically provides an electrical connection to the first electrical connector 21 or to the second electrical connector 22 via a bridging slot 6 which is located in the plug-in region.

The series terminal 4 may be a feed-through terminal in particular.

That is to say, by means of the invention, it is possible to provide a circuit breaker with base element, the protected potential of which can be distributed using jumpers to standard feed-through terminals. The jumper can only be removed or plugged-in if the circuit breaker is not plugged in the base element.

The jumper on the output side (protected potential) of the base element is voltage-free during handling and this is advantageous for electrical safety. Furthermore, the circuit breaker and the base element 2 are configured and arranged such that the distribution of the protected potential can take place using standard products and the protection can thus be expanded easily.

Without limiting the generality of the invention, the plugs can be provided with the circuit breaker for different current values and characteristic curves without it being necessary to change the base element 2.

Furthermore, without limiting the generality of the invention, it is possible in this manner to provide not only unipolar circuit breakers, but rather also multipolar circuit breakers. By appropriate configuration, these allow the distribution of a plurality of protected potentials by means of bridging slots 6 in the plug-in region, so that protection also exists in each case, as jumpers 3 or bridging slots 6 can only be reached when the plug 1 is unplugged. To this end, one base element 2 and one associated plug 3 can be provided e.g. for each pole. Alternatively, it may be provided that a plurality of circuit breakers (one per pole) are plugged into a common base element 2.

### LIST OF REFERENCE NUMBERS

1 Plug
2 Base element
3 Bridging plug
4 Series terminal
5 Mounting rail
6 Bridging slot
7 Release
21 First electrical connector
22 Second electrical connector

What is claimed is:

1. A plug-in circuit breaker for series mounting, having a base element and a plug,
the plug having a circuit breaker,
it being possible to plug the plug into the base element in a detachable manner,
the base element having mounting elements for mounting on a mounting rail (5),
the base element having at least one first electrical connector and one second electrical connector,
a first electrical connection being led in the base element from the first electrical connector into the plug-in region, so that a plug which is plugged-in is contacted,
a second electrical connection being led in the base element from the second electrical connector into the plug-in region, so that a plug which is plugged-in is contacted,
at least one first bridging slot for a bridging plug being arranged in the plug-in region, which provides an electrical connection to the first electrical connector or to the second electrical connector,
the plug in the plugged-in state also covering a bridging plug, so that this bridging plug cannot be removed.

2. The plug-in circuit breaker according to claim 1, wherein at least one second bridging slot for a second bridging plug is arranged in the plug-in region, wherein the first bridging slot provides an electrical connection to the first electrical connector and the second bridging slot provides an electrical connection to the second electrical connector.

3. The plug-in circuit breaker according to claim 1, wherein taps for sensor tips are provided on the base element.

4. The plug-in circuit breaker according to claim 1, wherein the circuit breaker in the plug is a mechanical circuit breaker, particularly a thermomagnetic circuit breaker.

5. The plug-in circuit breaker according to claim 1, wherein the circuit breaker is a mechanical circuit breaker or a thermal circuit breaker.

6. An ensemble having a plug-in circuit breaker according to claim 1 and a series terminal, which is arranged adjacent to the circuit breaker, wherein, by means of a bridging plug, the series terminal electrically provides an electrical connection to the first electrical connector or to the second electrical connector via a bridging slot which is located in the plug-in region.

7. The ensemble according to claim 6, wherein the series terminal is a feed-through terminal.
